(19) United States
(12) Patent Application Publication
(10) Pub. No.: US 2006/0248565 A1
(43) Pub. Date: Nov. 2, 2006

(54) Antenna for cable ingress/egress management signaling

(76) Inventors: Richard L. Shimp, Harrisonburg, VA (US); Mark Roberts, Gig Harbor, WA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/116,394

(22) Filed: Apr. 28, 2005

(51) Int. Cl. H04N 7/173; G06F 7/00; G06F 17/00; G05D 3/00; G01C 21/00; H04N 7/18; H04N 7/16; G05D 1/00

(52) U.S. Cl. 725/123; 725/121; 725/62; 725/75; 701/1; 701/200; 725/124; 725/125

(57) ABSTRACT

Radio signals are transmitted from a mobile detection unit such as a service vehicle in response to detection of signal egress from a cable distribution system such as a cable access television (CATV) system and coupled to the cable distribution system for upstream signaling by a resonant antenna such as a resonant loop or halo antenna and a sharply tuned filter to substantially eliminate other terrestrial or atmospheric signals being coupled to the cable distribution system. An optional attenuator may be included to limit signal energy in the upstream signal to prevent system damage. The mobile detection unit also preferably includes a global positioning system (GPS) receiver for determining position and time of any detection of signal egress or leaks and the transmitted radio signal preferably includes position and signal strength information. The radio signal is preferably transmitted in a burst having a duty cycle of 10% or less which may be multiplexed with signals from other mobile units preferably synchronized using the GPS time base.

### BACKGROUND OF THE INVENTION

1. Field of the Invention

The present invention generally relates to upstream signaling over a coaxial cable communication system, especially for the management, maintenance and repair of such coaxial cable communication systems and, more particularly, to the detection and reporting of cable defects, especially in cable broadcasting systems.

2. Description of the Prior Art

Coaxial cable communication or distribution systems, often referred to simply as “cable systems”, have proliferated in recent years, particularly for the broadcasting of television signals, referred to as cable access television or CATV, where the wide bandwidth of such systems supports the distribution of hundreds of channels of programming. Many areas of the United States and numerous other countries are now served by coaxial cable communication systems, often implemented with hybrid fiber optic and coaxial (HFC) cable connections and are capable of both downstream (e.g. broadcast) and upstream (e.g. telephone service, internet access, high speed data exchange, etc.) data transmission in different frequency bands.

However, conventional cable systems use the 50 MHz to 1 GHZ portion of the spectrum for downstream signaling and thus shares frequency allocation with conventional broadcasting and many other communication channels including important communications such as air traffic control communications to aircraft. (A frequency band of 5 to 50 MHz and which includes the so-called Citizens Band frequencies is generally preferred for upstream signaling.) This sharing of the spectrum is possible with limited interference because the energy of the signal is generally confined to a great degree within the coaxial cable which also excludes ingress of terrestrial electromagnetic signaling (e.g. transmissions through the atmosphere) and noise. That is, signal ingress and egress are reciprocal effects at any point of loss or reduction of shielding integrity and are often collectively referred to as leaks.

It is vitally important to the integrity of all communications in this band, both terrestrial and cable, to avoid egress of signals from the cable system and to avoid ingress of signals into the cable system, particularly as digital transmissions (which are subject to catastrophic failure when the level of noise or interference exceeds the level of inherent noise immunity and/or error recovery of digital signaling) are increased or are substituted for analog transmissions. Ingress of strong signals can also damage portions of the cable system such as repeaters and lasers at a fiber node which convert electrical signals in the upstream direction to an optical signal which is coupled to an optical fiber link in the system.

Therefore, all cable systems must be monitored at least on a frequent periodic basis as required by the Federal Communications Commission. In view of the generally large geographical extent of many cable systems and often substantial geographic separation of the coaxial cable distribution service area from a central facility of the cable system (a distance often and preferably covered by the optical fiber portion of the HFC), such monitoring represents a substantial cost factor in the overall cost of operating a cable system, including the substantial cost and amortization of monitoring equipment which must be deployed with high efficiency to limit those costs.

In general, such monitoring must be performed using a portable or mobile receiver which must be transported throughout the service area of a given cable system. When the receiver detects signals corresponding to signals broadcast over the system, a leak or point of signal egress is detected and may then be localized and repairs effected. Such repairs are usually performed by other personnel using equipment other than that which is used for leak detection since monitoring schedules and maximum utilization of leak detection equipment must be maintained to minimize costs. However, after the location of a leak is determined, the magnitude, nature and location of the problem must be reported in order for repair personnel and proper repair equipment to be dispatched.

A highly efficient system and method for such reporting and dispatch of repair equipment and personnel is disclosed in U.S. Pat. No. 5,777,662, which is assigned to the assignee of the present invention and fully incorporated herein by reference. That system and method exploits the fact that defects in coaxial shielding integrity have reciprocal egress and ingress effects, as alluded to above. That is, any leak in a cable system is not only a source of signal egress but could also serve as a point for ingress of not only ambient signals but also signals for upstream signaling to, for example, a central facility (such as a primary or secondary hub site or local, regional or national headend) for the cable system. As disclosed therein, upon detection of a leak by reception of a signal from the cable system by a mobile leak detection receiver, a Global Positioning System (GPS) receiver, also carried by a vehicle transporting the leak detection receiver, determines the location of the leak detection receiver, merges location information with other data indicating parameters of the detected signal and transmits a signal in the upstream band (e.g. 5 MHz to 50 MHz and preferably around 27 MHz, in or near the Citizens Band frequencies) which would enter the cable system at the point of the leak and be detected at a central facility to allow repair equipment and personnel to be dispatched.

Therefore, in essence, information regarding any leak in a cable system could be communicated over the cable system through the very fault being reported (or any other fault proximate to the point of detection or transmission for upstream signaling) and without necessitating a physical connection or coupling to the cable system or any other impediment to mobility of the leak detection receiver and associated transmitter. Processing of this data at the leak detection receiver and/or at the central facility can be automated to any desired degree and the communication does not require a separate communication link but only an upstream signaling channel in the cable system. In response, repair personnel and equipment can be directly dispatched from the central facility or the like using normal communication channels. Thus, maximum utilization of both personnel and equipment for both leak detection and repair can be achieved.

However, as cable technology has advanced, shielding of cables has improved and detection of signal egress and ingress of much smaller magnitude has become necessary while, at the same time, since the magnitude of both ingress and egress of signals is a function of the magnitude of the defect in shielding of the cable, the transmitter power required to practice the invention of the above-incorporated patent has increased to, if not beyond, the limit of practicality at the present time, particularly since the combination of smaller magnitude shielding defects and increased transmitter power greatly increases the range of signal strengths which may be coupled to the system. Further, since the preferred frequency band used for upstream signaling during the practice of the above-incorporated invention is close to Citizens Band frequencies, increased interference with the operation of the above-incorporated invention as well as with Citizens Band communications has been experienced. Additionally, a leak may occasionally be frequency selective such as by allowing substantial signal egress in the 50 MHz to 1 GHz band but allowing ingress only with substantial attenuation in the 5 MHz to 50 MHz band as noted in the above-incorporated patent which also provides for logging of transmissions intended for upstream signaling but which may not, in fact, have been adequately coupled to the cable system through a leak.

Nevertheless, use of upstream signaling for reporting locations of cable system leaks from a mobile receiver in a vehicle and without the need for a hardware connection to the cable system as disclosed in the above-incorporated patent has proven to be a highly efficient arrangement allowing much improved timeliness of repairs and high utilization of personnel and equipment. However, the reduced magnitude of faults which must be detected and the consequent increased attenuation of signals intended for ingress into the cable system for upstream signaling has reduced the number of transmissions intended for upstream signaling which are, in fact, successfully communicated.

### SUMMARY OF THE INVENTION

It is therefore an object of the present invention to provide an alternative system and method for monitoring cable system leakage which utilizes upstream signaling on the cable system without requiring a hardware coupling to the cable system.

It is another object of the invention to provide improved reliability of coupling of signals from a mobile transmitter transported with a mobile leak detection receiver for detecting leakage to a cable system for upstream signaling of information regarding such leakage and its location.

It is a further object of the invention to provide protection of elements of a cable system from damage due to excessive signal strength being coupled thereto for upstream signaling or inadvertently coupled from other sources.

In order to accomplish these and other objects of the invention, a coaxial cable leak detection and upstream signaling system is provided comprising at least one mobile unit comprising a leak detection receiver for detecting egress signals from a coaxial cable and providing leak detection information, a global positioning system (GPS) receiver providing location information and a time base, and a signal processor and transmitter for merging leak detection information and GPS location information and transmitting a signal containing the same, said leak detection receiver, and an upstream signal input coupler connected to said coaxial cable comprising a tuned antenna, an impedance matching circuit, and a tuned filter.

In accordance with another aspect of the invention, a method of coupling an upstream cable transmission signal to a cable signal distribution system is provided comprising steps of transmitting a radio signal in a frequency band different from the frequency band used for said signal distribution, receiving the radio signal using a resonant antenna, filtering signals received by the resonant antenna to substantially eliminate signals other than the radio signal to derive filtered radio signals, and coupling the filtered radio signals to the cable system.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A and 1B are depictions of the overall system in accordance with the invention, and

FIG. 2 is a schematic depiction of a preferred form of an antenna, filter and optional fixed attenuator in accordance with the invention.

### DETAILED DESCRIPTION OF A PREFERRED EMBODIMENT OF THE INVENTION

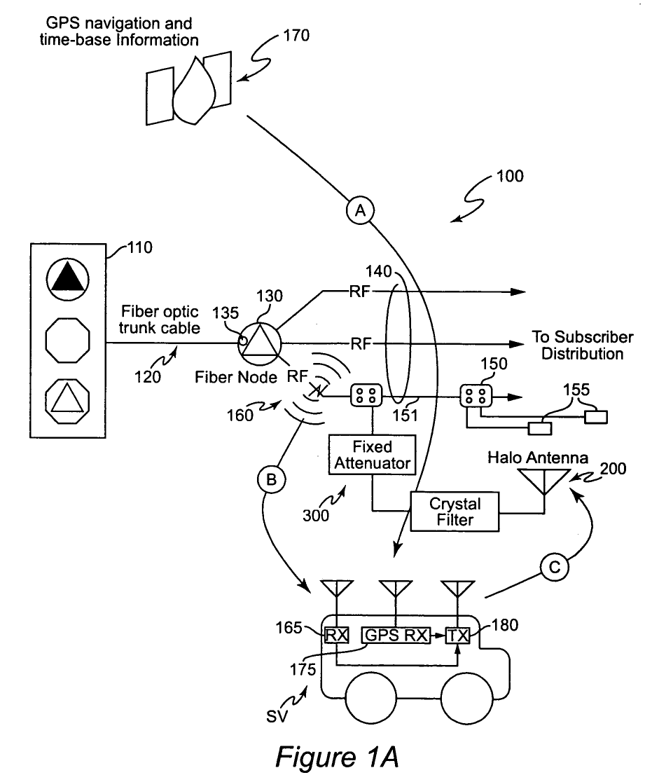

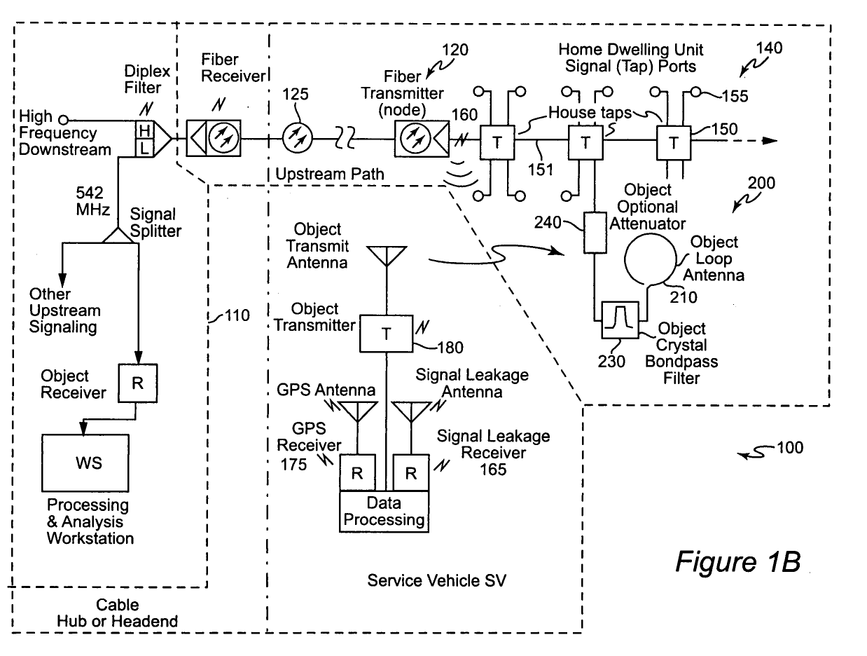

Referring now to the drawings, and more particularly to FIGS. 1A and 1B, there is shown an overview of an upstream signaling system in combination with a downstream signal distribution system in accordance with a preferred embodiment of the invention. (FIGS. 1A and 1B are intended to depict the same system architecture but are differently arranged and contain differing degrees of detail in respective portions of the system, as respectively illustrated in these Figures.) It should be understood that even though the preferred application of the invention is for upstream signaling in connection with detection (and repair) of coaxial cable faults in a coaxial cable or the coaxial portions of hybrid fiber optic and coaxial (HFC) cable communication system, particularly for distribution of television programming and the like, the system is broadly applicable to upstream signaling over a cable system for any purpose in any application where it may be advantageous to avoid a hardware connection to the cable system.

As depicted in FIGS. 1A and 1B, a cable system 100 to which the invention may be applied comprises at least a central facility 110 which may be a primary (indicated by a filled triangle in a circle) or secondary (indicated by an octagon) headend site or a local, regional or national hub site (indicated by an open triangle in an octagon) for a cable distribution system where data may be accumulated and processed in accordance with the invention, a (possibly fiber optic) trunk cable 120, a distribution arrangement, sometimes referred to as a bridging amplifier (indicated by an open triangle in a circle) 130 (which may be a simple coaxial coupler if trunk cable 120 is a coaxial cable) and a plurality of subscriber signal distribution cables 140 covering a service area, each subscriber signal distribution cable having a plurality of taps or couplers 150 to provide connections to individual subscribers and associated equipment (collectively represented at 155) such as set-top boxes (STBs). The system may, but need not, include a fiber optic trunk cable 120, in which case the distribution arrangement 130 would be a fiber node including a plurality of transducers for converting an optical signal into a plurality of electrical signals which are coupled to coaxial cables 140 and, since the system 100 is assumed, for purposes of this discussion, to provide for upstream signaling, a laser (schematically depicted at 135) is provided for converting the upstream electrical signals to optical signals which are coupled into the fiber optic trunk cable 120. Other known and commonly provided elements (schematically illustrated collectively at 125) such as a repeater may be freely included as needed or desired. All of these elements are individually known and preferred forms of some of which are illustrated and discussed in detail in the above-incorporated patent. For purposes of the following discussion, a shielding fault or other cable flaw allowing signal leakage is assumed and illustrated at 160.

Also, as discussed in the above-incorporated patent, cable system 100 is monitored using a mobile service vehicle SV. The service vehicle basically provides mobility for a signal leakage receiver 165 which detects signals transmitted downstream over the cable system 100 as depicted by arrow B. The signal leakage receiver is preferably tuned to any one of the cable television frequencies most sensitive to signal leakage control such as downstream channels 14 (121.2625 MHz) to 19 (151.2500 Mhz) inclusive. When coupled with a properly tuned vehicle roof-mount monopole antenna, the signal leakage receiver 165 recovers and quantifies free-space signals falling within its tuned bandpass. Quantified signal representations are then preferably clocked into a buffer preferably included in transmitter 180 along with overhead qualifiers such as packet headers under control of a microprocessor. Concurrently, a GPS receiver 175 receives position signals from one or more GPS satellites 170, as depicted by arrow A, so that the location of the service vehicle is or can be known at any given time. Time base signals are also received from the GPS satellite which may be used for system synchronization (e.g. signals from a plurality of service vehicles, as will be discussed below) or for detection of particular signals broadcast over the cable system or both. This information obtained from the GPS receiver 175 is multiplexed with the information from the leakage receiver 165 for transmission, again under control of the microprocessor. The microprocessor also preferably controls logging of transmissions on a portable storage medium (e.g. a floppy disk, compact flash memory or scan disk) for comparison with upstream communications received at central facility 110 as in the above-incorporated patent although the increased reliability of transmissions performed in accordance with the present invention greatly reduces the need for doing so. Nevertheless, such logging and comparison provides a measure of the effectiveness of the installation of a given instance of the invention as well as providing information related to the condition and operability of the system in accordance with the invention so that repairs and adjustments may be made in a timely fashion.

The GPS position and time information output from receiver 175 and desired parameters of the egress signal output by receiver 165 are then processed in a desired manner not critical to the successful practice of the invention but which can, upon appropriate analysis, provide a much enhanced level of confidence that the signal received by receiver 165 does, in fact, correspond to a signal transmitted downstream through cable system 100 rather than merely an ambient terrestrial communication in the frequency band of interest. The processing may be, for example, extraction of a digital signal packet header or actual transmitted data or test signal or even a comparison with a screen program monogram (e.g. a small, generally fixed image overlaid on the program video, usually placed in the corner of the display screen) with a channel on which it is broadcast on a given cable system at a given time or extraction of some statistical information over a short time period or the like in order to compare the detected signal with the signal transmitted downstream over the cable system which may be known in advance. The GPS time reference can be used at both the detection receiver 165 and at the central facility 110 for this purpose.

The necessary processing at the service vehicle may be quite minimal and is preferably performed by a processor included in transmitter 180 to form a short data burst which contains at least the reception time, the service vehicle location, and some signal parameters for identification and tentative or preliminary fault diagnosis, and, preferably, an indication of strength of the detected leakage signal which will assist in projecting the type of equipment and personnel which should be dispatched to effect a repair. The transmission of this information is depicted by arrow C in FIG. 1A.

It should be recognized that the cooperation of the cable system and the equipment carried by the service vehicle described above for leak detection does not differ significantly from the monitoring and maintenance system described in the above-incorporated patent. However, it is preferred at the present time and in the preferred environment of cable system monitoring and maintenance that the detection or leakage signal receiver 165, the GPS receiver 175 and the communications system transmitter 180 and its associated processor be embodied as a single vehicle data acquisition transceiver which acquires the data to be transmitted upstream (e.g. as a single box or single board device).

The transmission from transmitter 180 is preferably performed at a carrier frequency of one of 27.43 MHz. 27.45 MHz, 27.47 MHz and 27.49 MHz, slightly above the Citizen's Band frequencies and preferably transmits in a 10% duty cycle data burst. A 10% duty cycle burst is not critical to the practice of the invention but is preferred since a plurality of service vehicles may be operating in the area of the cable system at any given time and short bursts in different time slots (preferably time-multiplexed in accordance with the GPS time base data) reduces the potential for interference between them. In this regard, it is not necessary to discriminate or identify particular service vehicles, although that could be done in many ways which will be evident to those skilled in the art, but only to avoid the signaling from one service vehicle interfering with signaling from another service vehicle. That is, it is unimportant to the practice of the invention which of a plurality of service vehicles detects and reports a particular signal egress defect and, in fact, use of several vehicles may provide some useful degree of redundancy in this regard and, moreover, may provide information which allows the location of a fault to be more accurately determined (e.g. by triangulation based on received signal strength or any of a number of known algorithms and techniques familiar to those skilled in the art. While the frequency chosen is not particularly critical to the practice of the invention, use of a frequency which is different from frequencies where significant transmission traffic may be expected from transmitters which are also likely to be mobile is desirable for reasons which will now be discussed.

The invention basically functions as a port for connecting an upstream signal to a cable system but, in contrast to the above-incorporated patent in which a port was formed by the leak, itself, the invention provides improved coupling with improved predictability of an adequate connection being made as well as providing the ports at known locations in the service area. Further, in the above-incorporated patent, some degree of reliance was placed on the fact that transmitter 180 would be proximate to a fault or flaw in cable shielding when the leak was detected and could generally be assumed to be the transmitter closest thereto and thus to provide the signal which is strongest and most readily coupled to the cable through the leak whereas, when efficient coupling ports are provided in accordance with the present invention, it is necessary to limit the possibility of interference with the desired upstream signaling and to prevent an excessively strong signal from being coupled to the cable system where it could cause damage by overloading circuits, overdriving lasers and the like. Accordingly, the invention provides sharply limited tuning to reject frequencies other than those used by transmitters 180 and provides attenuation of signals above a given threshold as will now be discussed.

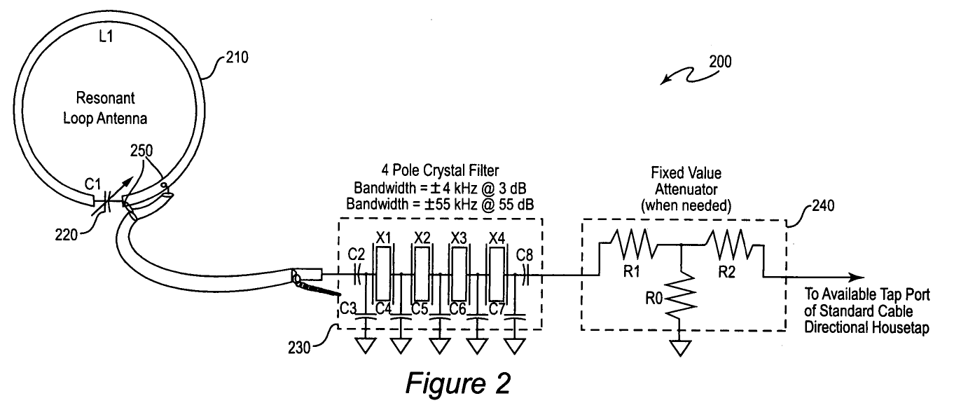

This port to the cable system is formed by a cable transport system signal input coupler generally indicated at 200 of FIG. 1 and which is illustrated in greater detail in FIG. 2. This input coupler serves to intercept the transmission burst from transmitter 180 and to inject the burst, preferably without significant modification, into the cable system. At the same time, the coupler substantially rejects all other free-space terrestrial transmissions to avoid interference and/or damage to the cable system. The coupler is also preferably embodied with only passive components to avoid a requirement for powering the coupler over the cable system.

The coupler preferably includes a tuned loop or halo antenna 210 since it can be tuned to exhibit a narrow bandpass which is sufficient to reject frequencies which are moderately separated from the preferred frequencies for transmitter 180. As is well-recognized in the art, the diameter of the loop defines the “Q” of the circuit and the usable bandpass. Since the antenna loop L1 is essentially inductive, tuning requires the addition of capacitance 220. To optimize power transfer and maintain theoretical circuit “Q”, the relatively high impedance must be transformed to a lower value to more closely match the impedance of the crystal filter 230, preferably embodied as a four-pole crystal filter. This is preferably accomplished by connecting at two separated points 250 along the antenna loop. That is, the antenna loop is tapped to provide an impedance to match the crystal filter impedance. The crystal filter, itself, is designed and custom manufactured to pass only signals within about ±4 KHz of the tuned center frequency, thus rejecting or severely attenuating closely separated carrier signals other than the chosen signaling frequency, such as Citizens Band radio transmissions, to substantially eliminate such received signals from the signal to be coupled to the cable system for upstream signaling. The narrow bandpass or communication bandwidth achieved by a four-pole crystal filter is entirely adequate for the limited signaling required for fault reporting in accordance with the invention or other relatively simple upstream signaling but may be inadequate for more complex upstream signaling functions such as telephone audio signaling and other bi-directional communication functions. By the same token, the present invention preferably uses only an extremely narrow band of the preferred upstream signaling spectrum located in close proximity to the Citizen's Band spectral allocation because use of this spectral region is otherwise generally avoided by the cable system operator and thus does not generally interfere with any other upstream signaling function which may be provided by the cable system.

In view of this tuning of the coupler in a highly selective manner, a large degree of protection for the upstream cable transport system is inherently provided. However, it may be advantageous in some installations, particularly where potentially damaging signal strength may be injected into the cable system due to selected directional tap 150 value, to provide an additional in-line attenuator 240; a preferred form of which is illustrated in FIG. 2 as a so-called T-network comprising resistors R1, R2 and R3, appropriate values for which in particular applications will be evident to those skilled in the art, but other forms of attenuator network can be used, as well. Thus the in-line attenuator can satisfy the requirements for elements such as repeaters and lasers in the upstream signaling path and any particular design philosophies embodied therein.

The upstream cable transport system may otherwise be entirely conventional; comprising directional taps 150, reverse amplifiers or repeaters 151 or the like, fiber node 130 with laser 135 and optical amplifiers, repeaters or the like 125 to carry the upstream signal to central facility 110 which will generally include a fiber/optical receiver, suitable splitter/combiner configurations and a receiver suitable for receiving the upstream signal carrier and recovering the transmitted data. It should be noted that, as a perfecting feature of the invention, the receiver 165 can also be arranged to detect egress of the upstream signal leaking from defect 160 in the coaxial to confirm upstream transmission, refine defect location estimation or the like. As alluded to above, the processing of the recovered signal is not critical to the practice of the invention but should preferably include some form of received signal logging for comparison with the transmitted signal log of the service vehicle to assure that all detected faults have, in fact, been reported.

While some time will be lost in dispatching repair personnel and equipment if a fault report is not received through upstream signaling in accordance with the invention, the vast majority of transmitted reports will be received in that manner and is much increased from the proportion of such reports made through the system of the above-incorporated patent at the present state of the cable shielding art and is achieved with much lower transmitted power which, in accordance with a perfecting feature of the invention can be adjusted in accordance with the known positions of signal input couplers 200 and the GPS information captured by GPS receiver 175 in the service vehicle in order to save power, minimize the occupation of the radio spectrum, and improve system operational integrity while maintaining suitable operating margins.

In view of the foregoing, it is seen that the invention provides an alternative system and method for monitoring cable signal egress and efficient and timely dispatch of repair equipment and personnel without requiring a hardware coupling to the cable system for upstream signaling. The invention also provides improved reliability of coupling of upstream signals (which may correspond to signaling applications other than cable leakage monitoring and reporting) to the cable system from a mobile service vehicle (or other vehicle or fixed location) and provides protection of elements of the upstream signaling transport system.

While the invention has been described in terms of a single preferred embodiment, those skilled in the art will recognize that the invention can be practiced with modification within the spirit and scope of the appended claims.

Having thus described my invention, what I claim as new and desire to secure by Letters Patent is as follows:

1. A coaxial cable upstream signaling system comprising
at least one mobile detection unit comprising
a leak detection receiver for detecting egress signals from a coaxial cable and providing leak detection information,
a global positioning system (GPS) receiver providing location information and a time base, and
a signal processor and transmitter for merging leak detection information and said GPS location information and transmitting a signal containing the same, said leak detection receiver, and
an upstream signal input coupler connected to said coaxial cable comprising
a tuned antenna,
an impedance matching circuit, and
a tuned filter.

2. A system as recited in claim 1, wherein said tuned antenna is a resonant loop antenna.

3. A system as recited in claim 1, wherein said tuned antenna includes a variable capacitance.

4. A system as recited in claim 1, wherein said tuned filter comprises a crystal filter.

5. A system as recited in claim 4, wherein said crystal filter comprises a four-pole crystal filter.

6. A system as recited in claim 1, further comprising an attenuator to limit the signal magnitude coupled to said upstream signal coupler.

7. A system as recited in claim 1, wherein said transmitter transmits a signal using a carrier frequency in the 5 MHz to 50 Mhz band.

8. A system as recited in claim 7, wherein said transmitter transmits a signal using a carrier frequency higher than frequencies allocated to a Citizens Band of frequencies.

9. A system as recited in claim 8, wherein said transmitter transmits a signal using a carrier frequency selected from the group consisting of 27.43 MHz, 27.45 MHz, 27.47 MHz and 27.49 MHz.

10. A system as recited in claim 1, wherein said transmitter transmits a signal in a burst having a duty cycle of 10% or less.

11. A system as recited in claim 1, including a plurality of said mobile units, transmissions from said transmitters of said plurality of mobile units being time-multiplexed.

12. A system as recited in claim 11. wherein said transmissions from said transmitters of said plurality of mobile units are multiplexed in accordance with said time base of said GPS receiver.

13. A system as recited in claim 1, wherein said leak detection receiver detects signals in a band of frequencies from 50 MHZ to 1 GHz.

14. A system as recited in claim 1, wherein said processor includes
means for logging transmissions from said transmitter.

15. A system as recited in claim 1, wherein said leak detection information includes
signal strength information.

16. A system as recited in claim 1, wherein said cable system is a hybrid fiber optical and coaxial cable system.

17. A method of coupling an upstream cable transmission signal to a cable signal distribution system, said method comprising steps of
transmitting a radio signal in a frequency band different from a frequency band used for said signal distribution,
receiving said radio signal using a resonant antenna,
filtering signals received by said resonant antenna to substantially eliminate signals other than said radio signal to derive filtered radio signals, and
coupling said filtered radio signals to said cable system.

18. A method as recited in claim 17, wherein said filtering step is preformed with a crystal filter.

19. A method as recited in claim 17, wherein said resonant antenna is a resonant loop antenna.

20. A method as recited in claim 17, wherein said method is performed in response to detection of signal egress from said cable system.
